(19) United States
(12) Patent Application Publication
(10) Pub. No.: US 2004/0148182 A1
(43) Pub. Date: Jul. 29, 2004

(54) Methods for marketing and generating revenue from chewing gum products

(76) Inventors: David B. Kroll, Chicago, IL (US); Steven P. Barton, Chicago, IL (US); Donna M. Dikselis, Oak Lawn, IL (US)

Correspondence Address: BELL, BOYD & LLOYD LLC, P. O. BOX 1135, CHICAGO, IL, 60690-1135, US

(21) Appl. No.: 10/354,681

(22) Filed: Jan. 29, 2003

(51) Int. Cl. G06F 17/60

(52) U.S. Cl. 705/1

(57) ABSTRACT

Methods for generating revenue from chewing gum products and methods for marketing same. A variety of methods of generating revenue and marketing rolled tape chewing gum products are provided. In an embodiment, a method for marketing chewing gum is provided comprising the steps of selecting a brand name for a chewing gum that has a flavor and selling the chewing gum in stick form. At a later date, the brand name is used on a chewing gum product having the flavor but having a rolled tape form.

### BACKGROUND OF THE INVENTION

The present invention relates to the marketing of confectionery products. More specifically, the present invention relates to the marketing of chewing gum products.

It is of course known to sell a variety of edible products including confectionery products. Confectionery products typically refer to edible products that are sweet such as candy, chewing gum, and other sugar or sweetener-containing compositions. A variety of confectionery products are marketed by a large number of companies. These products include hard candies, mints, chewing gum, both sugarless and sugar-containing, bubble gum, gummi candies, liquid candies, and powdered candies. The variety and types of confectionery products continues to evolve and grow.

Chewing gum products have been provided for a great number of years. Chewing gum typically consists of an insoluble gum base and a water soluble portion. The water soluble portion provides a flavor and sweetener.

A variety of chewing gum products have been sold. These products vary in taste (flavor) and sweetness. They can contain sugar or an artificial sweetener, or both. Chewing gum products have been molded, extruded, or otherwise shaped into various forms. For example, bubble gum has been formed into shapes such as cigars, shredded chew, and rolled tape. See, for example, U.S. Pat. No. 4,882,175. An example of a rolled tape product is Bubble Tape® bubble gum sold by Amurol Confections.

It is known to provide chewing gum in stick form. One of the disadvantages of stick chewing gum is that typically the chewing gum is individually wrapped. In order to provide a shelf-stable product, typically the wrapper includes foil or other moisture-impermeable material. Individually wrapped sticks are then packaged with a number of other sticks in a further pouch which may or may not include a foil wrapper. Typically, the requisite packaging required for stick chewing gum increases the cost as well as manufacturing time for the chewing gum product. In addition, the consumer must dispose of the wrappers after removing the chewing gum for consumption.

### SUMMARY OF THE INVENTION

Generally, the present invention provides methods for generating revenue from chewing gum products and methods for marketing same. For example, pursuant to the present invention, a variety of methods of generating revenue and marketing rolled tape chewing gum products are provided.

To this end, in an embodiment of the present invention a method for marketing chewing gum is provided comprising the steps of selecting a brand name for a chewing gum that has a flavor and selling the chewing gum in stick form. At a later date, the brand name is used on a chewing gum product having the same flavor but having a rolled tape form.

In an embodiment, the chewing gum in stick form is packaged in a wrapper including foil.

In an embodiment, the later date is at least one year.

In an embodiment, the chewing gum is not bubble gum.

In an embodiment, the brand name is used simultaneously with both the stick form and rolled tape form of chewing gum.

In an embodiment, the brand name is used in the same font on both the stick form and rolled tape form of chewing gum.

In another embodiment of the present invention, a method of marketing products is provided comprising the steps of: selling a chewing gum product in stick form; selling a chewing gum product in rolled tape form; and wherein each of the chewing gum forms are sold with a common brand name as well as a common distributor's name.

In an embodiment, the chewing gum in rolled tape form is sold in a container that has a plastic body.

In an embodiment, the chewing gum product in stick form is sold with the common brand prior to the sale of the chewing gum in rolled tape form.

In an embodiment, only one flavor of chewing gum is sold under the common brand name.

In yet another embodiment of the present invention, a method of marketing chewing gum is provided comprising the steps of using a brand name on a form of chewing gum that is the same as a brand name that is used on a different form of chewing gum.

In an embodiment, the chewing gum forms have different cross-sectional shapes.

In an embodiment, one chewing gum form is a stick shape and the other chewing gum form is a rolled tape shape.

In an embodiment, the chewing gum forms have the same flavor.

Still, in another embodiment of the present invention, a method of eliminating paper wrappers from chewing gum that has been sold in stick form is provided comprising the steps of manufacturing and selling the chewing gum in a rolled tape form using the same brand name and flavor as was used with the stick form of the chewing gum.

In an embodiment, the chewing gum in rolled tape form is sold with an indicia that is the same as an indicia used on a wrapper of the chewing gum in stick form.

In another embodiment of the present invention, a method of generating revenues is provided comprising the steps of manufacturing chewing gum in rolled tape form that has the same flavor and brand name as chewing gum that has been sold in stick form and selling the chewing gum in rolled tape form to a consumer.

And, in an further embodiment of the present invention, a method of marketing chewing gum is provided comprising the step of providing a plurality of chewing gum products having a flavor under a single brand name, the chewing gum products varying in at least shape and packaging.

In an embodiment, the shapes include stick form and rolled tape form.

In an embodiment, the packaging includes paper, foil, and plastic.

It is an advantage of the present invention to provide improved methods of generating revenue from chewing gum products.

Moreover, an advantage of the present invention is to provide improved methods of marketing chewing gum products.

Furthermore, an advantage of the present invention is to provide an improved method for marketing rolled tape chewing gum.

Another advantage of the present invention is to provide improved methods of generating revenue from rolled tape chewing gum.

Still further, an advantage of the present invention is to provide improved methods of branding products.

Further, an advantage of the present invention is to enhance the marketability of chewing gum products.

Additional features and advantages of the present invention are described in, and will be apparent from, the detailed description of the presently preferred embodiments and the drawings.

### BRIEF DESCRIPTION OF THE DRAWINGS

FIG. 1 illustrates a perspective view of a stick chewing gum product.

FIG. 2 illustrates a perspective view of a stick of chewing gum in a wrapper.

FIG. 3 illustrates a perspective view of a rolled tape chewing gum product.

FIG. 4 illustrates a perspective view of a rolled tape chewing gum product package.

### DETAILED DESCRIPTION OF THE INVENTION

The present invention provides improved methods of generating revenue from chewing gum products as well as methods of marketing same. More specifically, the present invention provides an improved method of marketing and generating revenue from rolled tape chewing gum products.

As used herein, the term “rolled tape chewing gum” or “rolled tape form” means a product that includes an insoluble base portion and a water soluble portion. The product in an unwound state is thin, flat, and generally rectangular having a length of at least six inches, but preferably greater than or equal to 12 inches. The product is sold in a wound or rolled state wherein at least a majority of a top side of the product contacts a bottom side of the product.

In contrast, as used herein “stick chewing gum” or “stick form” means a product that is thin, flat, and generally rectangular but having a length of less than 6 inches that is sold in a flat, unwound state.

In general, the present invention provides methods of marketing chewing gum products. In an embodiment, the present invention includes the method of marketing a rolled tape chewing gum product using the same brand name as used on a stick chewing gum product. Preferably, the brand name was used on the stick product prior to being used on the rolled tape chewing gum product.

As used herein, “brand name” refers to a designator for a product or a group of products. Examples of brand names are the “Juicy Fruit,” “Doublemint,” “Eclipse,” “Extra,” “Orbit,” “Freedent,” and “Big Red” trademarks that are used by Wm. Wrigley Jr. Company.

By using the same brand name on different chewing gum products, customer loyalty can be established. This loyalty can extend not only through one product line, but different product lines, e.g., different chewing gum products.

For example, pursuant to the present invention, a brand name will first be used on a stick of chewing gum. Then, the brand name will be used on a rolled tape chewing gum product. In addition to the brand name, the products will also include, preferably, the name of the distributor and/or manufacturer. If desired, each of the different products may include other product identifiers. However, it is important that each include the same brand name so the consumer associates both products with the same brand name, even though the form of the products is different.

Therefore, pursuant to the present invention, it is not necessary for a new brand name to be selected and used on different chewing gum products. In this regard, it is possible to expand a brand name in other areas. For example, a brand name that has been associated with a stick of chewing gum can be used on a rolled tape film product. Thus, it is possible to increase the marketability of the new product, such as rolled tape product, by using an established brand name on a new type of product, e.g., Juicy Fruit® rolled tape chewing gum. This will create immediate customer recognition and loyalty.

Preferably, the brand name will be used on the package containing the chewing gum product in the same manner. Therefore, the brand name preferably will be in the same design and font on each of the different packaging for the products. However, it is possible that the brand name can be in a different design, font, color, or vary from product form to product form.

It should be noted that a variety of chewing gum products can be utilized. In addition, a variety of different flavors can be utilized. Preferably, the same flavor, and indeed to the extent possible the same formulation, will be used whether the product is a stick chewing gum or rolled tape chewing gum product.

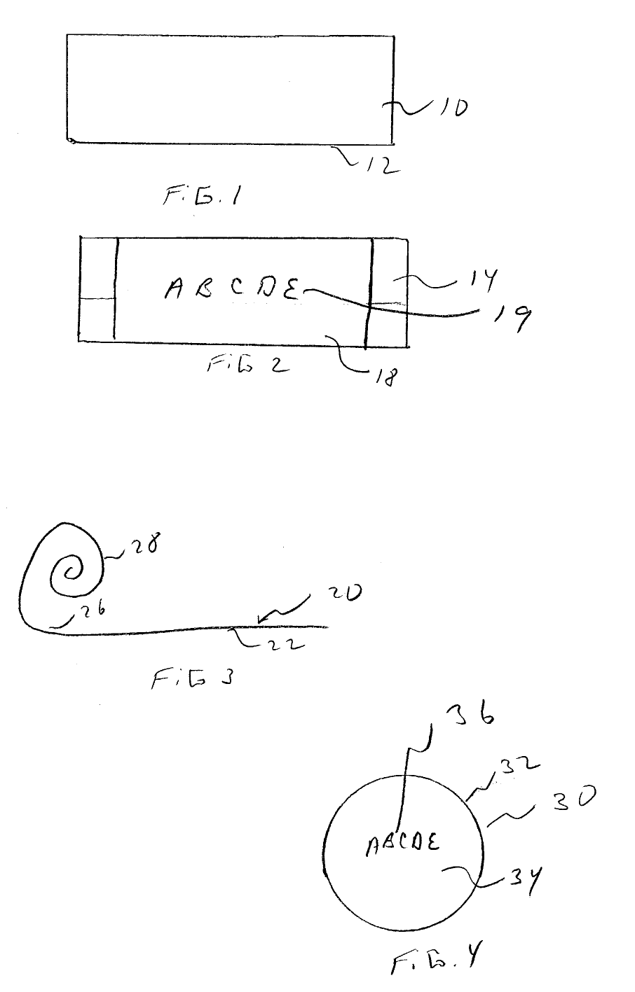

Referring to the figures, FIG. 1 illustrates a stick of chewing gum 10. As illustrated, the stick of chewing gum 10 is defined by a body 12 that has a substantially rectangular cross-sectional shape.

Referring now to FIG. 2, the body of the chewing gum is enclosed in a wrapper 14, typically a somewhat moisture impermeable wrapper 14 encloses the body. A second wrapper 18 or sleeve encloses a portion of the first wrapper 14 securing same around the chewing gum. The second wrapper 18 typically includes indicia 19 identifying the brand name.

Referring to FIG. 3, a rolled tape chewing gum product 20 is illustrated. Preferably, the rolled tape chewing gum product is manufactured using a method such as that disclosed in U.S. Pat. No. 4,882,175, the disclosure of which is hereby incorporated by reference. Briefly, the process includes the following steps. First, a mass of a chewing gum is provided. This mass is formed into a thin flat, generally rectangular sheet. The flat sheet is then rolled about the leading edge of the sheet. The rolled flat sheet is cut in planes generally perpendicular to the leading edge. Consequently, individual pieces of the chewing gum product are produced in the predetermined width and in the form of a rolled tape.

To accomplish the method an apparatus is used that includes means for forming a mass of chewing gum product into a thin, flat, generally rectangular sheet. The apparatus further includes means for rolling the flat sheet about its leading edge, and means for cutting the rolled flat sheet in planes generally perpendicular to the leading edge.

In an embodiment of the method, the chewing gum is preferably cut by scoring the sheet of gum along lines generally perpendicular to the leading edge of the sheet. After the sheet is rolled up, it is separated into individual pieces by breaking the roll along the score lines.

In a preferred embodiment, the flat sheet is cored laterally only to cut the sheet to the desired length. In alternative embodiments, the flat sheet is also scored laterally so as to aid the consumer in breaking off predetermined lengths of the confectionery product. For example, the sheet could be scored at lengths from 1 foot to 4 feet. Naturally, such additional lateral scoring would be at depths shallower than that of the main lateral score which is used to separate individual flat sheets.

Referring back to FIG. 2, as illustrated, the body 22 of the rolled tape product has a generally elongated rectangular shape. Preferably, this tape is between about 1 foot and about 12 feet long, more preferably 3 to about 6 feet. The width of the body 22 of the gum 20 is preferably the same as that for a conventional stick of chewing gum, e.g., 0.75″. Alternatively, the width can vary between about 0.25″ and about 2″. As illustrated, the chewing gum is “rolled” so that top surfaces 26 contact bottom surfaces 28 of the chewing gum.

FIG. 4 illustrates a preferred container 30 for the rolled tape chewing gum 20. The package comprises a relatively flat cylindrical cup 32 with a lid 34. The rolled tape chewing gum 20 is received within an interior of the container. Alternatively, other forms of packaging can be used, such as a more sophisticated plastic dispenser, a fin-sealed cellophane package or a small box.

The container 30, and in an embodiment, the lid 34 can contain an indicia 36 for identifying the product, e.g., the brand name. In an embodiment, this indicia will be the same as the indicia 19 used on the wrapper 18 of stick form of the chewing gum 10.

A variety of different chewing gums and formulations can be utilized to create either a stick chewing gum or a rolled tape chewing gum product. Such chewing gums include a water insoluble gum base, a water soluble portion, and flavor. The water soluble portion dissipates with a portion of the flavor of the gum over a period of time during chewing. The gum base portion is retained in the mouth throughout the chew.

The insoluble gum base generally comprises elastomers, resins, fats and oils, softeners and inorganic fillers. The gum base may or may not include wax. Typically, gum base comprises approximately 20 to about 40% of the gum product. However, because in the present invention such a high level of coating is used, the gum center is unusually small; otherwise the entire coating chewing gum piece would be too large for consumption. If a typical amount of gum base was used in the small gum center, it would result in an inadequate cud to masticate. Consequently, in the present invention, the base level is higher than normal. The insoluble gum base can constitute approximately 30% to about 90% by weight of the chewing gum, in an embodiment, the gum base comprises at least 50% of the chewing gum.

In an embodiment, the chewing gum base of the present invention contains about 20% to about 60% by weight synthetic elastomer, about 0% to about 30% by weight natural elastomer, about 5% to about 55% by weight elastomer plasticizer, about 4% to about 35% by weight filler, about 5% to about 35% by weight softener, and optional minor amounts (about 1% or less by weight) of miscellaneous ingredients such as colorants, antioxidants, etc.

Synthetic elastomers may include, but are not limited to, polyisobutylene with GPC weight average molecular weight of about 10,000 to about 95,000, isobutylene-isoprene copolymer (butyl elastomer), styrene-butadiene, copolymers having styrene-butadiene ratios of about 1:3 to about 3:1, polyvinyl acetate having GPC weight average molecular weight of about 2,000 to about 90,000, polyisoprene, polyethylene, vinyl acetate—vinyl laurate copolymer having vinyl laurate content of about 5% to about 50% by weight of the copolymer, and combinations thereof.

Preferred ranges for polyisobutylene are 50,000 to 80,000 GPC weight average molecular weight and for styrene-butadiene are 1:1 to 1:3 bound styrene-butadiene, for polyvinyl acetate are 10,000 to 65,000 GBC weight average molecular weight with the higher molecular weight polyvinyl acetates typically used in bubble gum base, and for vinyl acetate-vinyl laurate, vinyl laurate content of 10-45%.

Natural elastomers may include natural rubber such as smoked or liquid latex and guayule as well as natural gums such as jelutong, lechi caspi, perillo, sorva, massaranduba balata, massaranduba chocolate, nispero, rosindinha, chicle, gutta hang kang, and combinations thereof. The preferred synthetic elastomer and natural elastomer concentrations vary depending on whether the chewing gum in which the base is used is adhesive or conventional, bubble gum or regular gum, as discussed below. Preferred natural elastomers include jelutong, chicle, sorva and massaranduba balata.

Elastomer plasticizers may include, but are not limited to, natural rosin esters such as glycerol esters or partially hydrogenated rosin, glycerol esters of polymerized rosin, glycerol esters of partially dimerized rosin, glycerol esters of rosin, pentaerythritol esters of partially hydrogenated rosin, methyl and partially hydrogenated methyl esters of rosin, pentaerythritol esters of rosin; synthetics such as terpene resins derived from alpha-pinene, beta-pinene, and/or d-limonene; and any suitable combinations of the foregoing. The preferred elastomer plasticizers will also vary depending on the specific application, and on the type of elastomer which is used.

Fillers/texturizers may include magnesium and calcium carbonate, ground limestone, silicate types such as magnesium and aluminum silicate, clay, alumina, talc, titanium oxide, mono-, di- and tri-calcium phosphate, cellulose polymers, such as wood, and combinations thereof.

Softeners/emulsifiers may include tallow, hydrogenated tallow, hydrogenated and partially hydrogenated vegetable oils, cocoa butter, glycerol monostearate, glycerol triacetate, lecithin, mono-, di- and triglycerides, acetylated monoglycerides, fatty acids (e.g. stearic, palmitic, oleic and linoleic acids), and combinations thereof.

Colorants and whiteners may include FD&C-type dyes and lakes, fruit and vegetable extracts, titanium dioxide, and combinations thereof.

The base may or may not include wax. An example of a wax-free gum base is disclosed in U.S. Pat. No. 5,286,500, the disclosure of which is incorporated herein by reference.

In addition to a water insoluble gum base portion, a typical chewing gum composition includes a water soluble bulk portion and one or more flavoring agents. The water soluble portion can include bulk sweeteners, high-intensity sweeteners, flavoring agents, softeners, emulsifiers, colors, acidulants, fillers, antioxidants, and other components that provide desired attributes.

Softeners are added to the chewing gum in order to optimize the chewability and mouth feel of the gum. The softeners, which are also known as plasticizers and plasticizing agents, generally constitute between approximately 0.5% to about 15% by weight of the chewing gum. The softeners may include glycerin, lecithin, and combinations thereof. Aqueous sweetener solutions such as those containing sorbitol, hydrogenated starch hydrolysates, corn syrup and combinations thereof, may also be used as softeners and binding agents in chewing gum.

Bulk sweeteners include both sugar and sugarless components. Bulk sweeteners typically constitute about 5% to about 95% by weight of the chewing gum, more typically, about 20% to about 80% by weight, and more commonly, about 30% to about 60% by weight of the gum. Sugar sweeteners generally include saccharide-containing components commonly known in the chewing gum art, including but not limited to, sucrose, dextrose, maltose, dextrin, dried invert sugar, fructose, levulose, glactose, corn syrup solids, and the like, alone or in combination. Sugarless sweeteners include, but are not limited to, sugar alcohols such as sorbitol, mannitol, xylitol, hydrogenated starch hydrolysates, maltitol, and the like, alone or in combination.

High-intensity artificial sweeteners can also be used, alone or in combination, with the above. Preferred sweeteners include, but are not limited to, sucralose, aspartame, salts of acesulfame, altitame, saccharin and its salts, cyclamic acid and its salts, glycerrhizinate, dihydrochalcones, thaumatin, monellin, and the like, alone or in combination. In order to provide longer lasting sweetness and flavor perception, it may be desirable to encapsulate or otherwise control the release of at least a portion of the artificial sweetener. Such techniques as wet granulation, wax granulation, spray drying, spray chilling, fluid bed coating, coacervation, and fiber extension may be used to achieve the desired release characteristics.

Combinations of sugar and/or sugarless sweeteners may be used in chewing gum. Additionally, the softener may also provide additional sweetness such as with aqueous sugar or alditol solutions.

If a low calorie gum is desired, a low caloric bulking agent can be used. Examples of low caloric bulking agents include: polydextrose; Raftilose, Raftilin; Fructooligosaccharides (NutraFlora); Palatinose oligosaccharide; Guar Gum Hydrolysate (Sun Fiber); or indigestible dextrin (Fibersol). However, other low calorie bulking agents can be used.

A variety of flavoring agents can also be used, if desired. The flavor can be used in amounts of about 0.1 to about 15 weight percent of the gum, and preferably, about 0.2% to about 5% by weight. Flavoring agents may include essential oils, synthetic flavors or mixtures thereof including, but not limited to, oils derived from plants and fruits such as citrus oils, fruit essences, peppermint oil, spearmint oil, other mint oils, clove oil, oil of wintergreen, anise and the like. Artificial flavoring agents and components may also be used. Natural and artificial flavoring agents may be combined in any sensorially acceptable fashion.

By way of example and not limitation, examples of the present invention will now be given:

### EXAMPLE NO. 1

A stick chewing gum product is sold that is substantially similar to that illustrated in FIG. 1 with a wrapper such as that in FIG. 2. The chewing gum product bears the Juicy Fruit® trademark.

After establishing a brand loyalty to the Juicy Fruit® product including the taste and flavor, a rolled tape chewing gum product is sold. The rolled tape chewing gum product comprises substantially the same formulation as the Juicy Fruit® product and has the same taste. However, the product is in a rolled tape chewing gum form such as that illustrated in FIG. 3. The same brand name in the same font is used on the package of FIG. 4 to market the product.

### EXAMPLE NO. 2

A stick chewing gum product is sold under the Doublemint® trademark. The wrapper containing the product includes the Doublemint® trademark in a specific font.

After establishing a brand loyalty, a rolled tape chewing gum product is sold having the same flavor and taste as the Doublemint® product. The same brand name is used on the container that houses the Doublemint® rolled tape product. However, the Doublemint® brand name is in a different font.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A method for marketing chewing gum comprising the steps of:
selecting a brand name for a chewing gum that has a flavor and selling the chewing gum in stick form, at least a portion of a packaging that houses the stick form including the brand name; and
using the brand name at a later date on a rolled tape chewing gum product having the flavor, a portion of a container that houses the rolled tape chewing gum including the brand name.

2. The method of claim 1 wherein the chewing gum in stick form is packaged in a wrapper including foil.

3. The method of claim 1 wherein the later date is at least one year.

4. The method of claim 1 wherein the chewing gum is not bubble gum.

5. The method of claim 1 wherein the brand name is used simultaneously with both the stick form of chewing gum and rolled tape form of chewing gum.

6. The method of claim 1 wherein the brand name is used in the same font on both the stick form of chewing gum and rolled tape form of chewing gum.

7. A method of marketing products comprising the steps of:
selling a chewing gum product in a stick form;
selling a chewing gum product in a rolled tape form; and
wherein each of the chewing gum forms are sold with a common brand name as well as a common distributor's name.

8. The method of claim 7 wherein the chewing gum in the stick form is sold in a package including a plurality of wrapped individual units.

9. The method of claim 7 wherein the chewing gum in the rolled tape form does not include paper packaging.

10. The method of claim 7 wherein the chewing gum in rolled tape form is packaged in a container having a body comprising plastic.

11. The method of claim 7 wherein the chewing gum product in the stick form is sold with the common brand prior to the sale of the chewing gum in the rolled tape form.

12. The method of claim 7 wherein only one flavor of chewing gum is sold under the common brand name.

13. A method of marketing chewing gum comprising the steps of using a brand name on a form of chewing gum that is the same as a brand name that is used on a different form of chewing gum.

14. The method of claim 13 wherein the chewing gum forms have different cross-sectional shapes.

15. The method of claim 13 wherein one chewing gum form is a stick form and the other chewing gum form is a rolled tape form.

16. The method of claim 13 wherein the chewing gum forms have the same flavor.

17. The method of claim 13 wherein each of the forms are housed and sold to a consumer in a different container.

18. A method of eliminating paper wrappers from chewing gum that has been sold in stick form comprising the steps of manufacturing and selling the chewing gum in a rolled tape form using the same brand name and flavor as was used with the stick form of chewing gum.

19. The method of claim 18 wherein the chewing gum in rolled tape form is sold with an indicia that is the same as an indicia used on a wrapper of the chewing gum in stick form.

20. The method of claim 18 wherein the chewing gum in rolled tape form is housed and sold to a consumer in a container comprising plastic.

21. A method of generating revenues comprising the steps of:
providing chewing gum in a rolled tape form that has a flavor and uses a brand name on a packaging that houses the chewing gum in rolled tape, the flavor and brand name being the same as the flavor of a chewing gum that has been sold in a stick form and the brand name used on a package that houses the chewing gum in stick form; and
selling the chewing gum in the rolled tape form to a consumer.

22. The method of claim 21 wherein the rolled tape form of chewing gum is packaged in a plastic container.

23. A method of marketing chewing gum comprising the step of providing a plurality of chewing gum products having a flavor under a single brand name, the chewing gum products varying in at least shape and packaging.

24. The method of claim 23 wherein the shapes include stick form and rolled tape form.

25. The method of claim 23 wherein the packaging is chosen from the group consisting of paper, plastic, and foil.

26. A method for increasing sales of chewing gum product under a single brand name comprising the steps of:
selling a stick form of chewing gum product that has a taste when chewed and is housed in a first package;
selling a rolled tape form of chewing gum product having the taste when it is chewed, the rolled tape form being housed in a second package; and
using the same brand name on the first and second packages.

27. A method of providing chewing gum products to consumers comprising the steps of:
selling a chewing gum product in a stick form;
selling a chewing gum product in a rolled tape form that has the same formulation as the stick form; and
wherein each of the chewing gum forms are sold with a common brand name.
